(19) United States
(12) Patent Application Publication
(10) Pub. No.: US 2002/0130887 A1
(43) Pub. Date: Sep. 19, 2002

(54) Image manipulation display device and storage medium for the same

(76) Inventor: Haruo Yamamoto, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 09/809,180

(22) Filed: Mar. 16, 2001

(51) Int. Cl. G09G 5/00

(52) U.S. Cl. 345/619

(57) ABSTRACT

The image manipulation display device according to the present invention provides an image manipulation display device which displays work screen in a display section 2, and carries out a specified work through the continuous operation with a keyboard 3, comprising an image memory 7 for storing any one or any two or more of image data for resting the eyes, muscles, or mind, image data for canceling the eye fatigue, and image data for game; and a CPU 5 which, for said display section 2, selects the work screen or any one or any two or more of rest screen based on the image data for rest which is stored in the image memory 7, eye fatigue cancel screen based on the image data for eye fatigue cancel which is stored in the image memory 7, and game screen based on the image data for game which is stored in the image memory 7.

### BACKGROUND OF THE INVENTION

1. Field of the Invention

The present invention relates to an image manipulation display device and a storage medium for image manipulation display device which allow the manipulator/worker to automatically or manually recover from the fatigue of the eyes, the stiffness of shoulders and the like.

2. Prior Art

With conventional image manipulation display devices, such as a computer and a word processor, the work screen for such a purpose as document creation is displayed in the display section, such as a CRT, and a liquid crystal display, and the manipulator/worker carries out a specified work, such as document creation, through the continuous operation while viewing the work screen.

With conventional image manipulation display devices, such as a computer game machine, the game screen is displayed in the display section, and the player enjoys the game through the continuous operation by manipulating the lever or the like while viewing the screen.

### PROBLEMS TO BE SOLVED BY THE INVENTION

However, with conventional image computers, word processors, and the like, only the work screen is continued to be displayed in the display section with no special change, and also with conventional computer game machines, and the like, only the game screen is continued to be displayed in the display section with no special change.

As a result of this, problems of that the manipulator/worker and the player enjoying the game have a severe fatigue or stiffness of shoulders, and that mental stresses are built up, which has an ill effect on the health, have been presented. Further, with conventional television sets, the same problems as stated above have been caused.

Then, in consideration of the above situation, the present invention has been developed to provide an image manipulation display device which allow the manipulator/worker of it to automatically recover from the fatigue of the eyes, the stiffness of shoulders and the like, and prevent metal stresses from being built up, and a storage medium for image manipulation display device that is suitable for use with such image manipulation display device.

### MEANS TO SOLVE THE PROBLEMS

The invention according to claim 1 provides an image manipulation display device which displays work screen on display means, and carries out a specified work through the continuous operation with input means, comprising image memory means for storing any one or any two or more of image data for resting the eyes, muscles, or mind, image data for canceling the eye fatigue, and image data for game; and control means which, for said display means, selects said work screen or any one or any two or more of rest screen based on the image data for rest which is stored on said image memory means, eye fatigue cancel screen based on the image data for eye fatigue cancel which is stored on said image memory means, and game screen based on the image data for game which is stored on said image memory means.

With this invention, the rest screen, the eye fatigue cancel screen or the game screen is automatically displayed while the work screen is being displayed on said display means for carrying out a specified work, thus, the manipulator/worker can view or manipulate such various screens to automatically cancel the fatigue of the eyes or the stiffness of shoulders, eliminate the mental stresses, or cancel the stresses due to playing the game.

The invention according to claim 2 provides an image manipulation display device which displays work screen on display means, and carries out a specified work through the continuous operation with input means, comprising image memory means for storing any one or any two or more of image data for resting the eyes, muscles, or mind, image data for canceling the eye fatigue, and image data for game; record and reproduction means for recording and reproducing a piece of music for rest; and control means which, for said display means, selects said work screen or any one or any two or more of rest screen based on the image data for rest which is stored on said image memory means, eye fatigue cancel screen based on the image data for eye fatigue cancel which is stored on said image memory means, and game screen based on the image data for game which is stored on said image memory means, and sounds the piece of music recorded on said record and reproduction means while the rest screen, the eye fatigue cancel screen, or the game screen is being displayed.

With this invention, the music for rest sounds in addition to the functions of the invention according to claim 1, while the rest screen or the eye fatigue cancel screen is being displayed, thus, the manipulator/worker can not only visually but also aurally eliminate the stresses.

The invention according to claim 3 provides an image manipulation display device as set forth in claim 1 or 2, wherein said control means has a function which allows a manipulator/worker to arbitrarily and freely set the switchover timing for the work screen, the rest screen, the eye fatigue cancel screen, and the game screen.

With this invention, the manipulator/worker can arbitrarily and freely set the switchover timing for the work screen, the rest screen, the eye fatigue cancel screen, and the game screen, thus, an optimum working environment to suit to the preference of the manipulator/worker can be built.

The invention according to claim 4 provides an image manipulation display device as set forth in any one of claims 1 to 3, wherein said input means comprises a switching section for the work screen, the rest screen, the eye fatigue cancel screen, and the game screen, and said control means selects the work screen, or any one or any two or more of the rest screen, the eye fatigue cancel screen, and the game screen in response to a signal from said switching section.

With this invention, the switchover timing can be set with the switching section in the input means, thus, an optimum working environment to suit to the preference or the degree of ease of becoming fatigued of the manipulator/worker can be built.

The invention according to claim 5 provides a storage medium for image manipulation display which can function, being incorporated in an image manipulation display device which displays work screen on display means, and carries out a specified work through the continuous operation with input means, wherein an operation program which contains any one or any two or more of image data for resting the eyes, muscles, or mind, image data for canceling the eye fatigue, image data for game, and music data for rest is stored; and under control by control means for said image manipulation display device, the work screen or any one or any two or more of rest screen based on said image data for rest, eye fatigue cancel screen based on said image data for eye fatigue cancel, and game screen based on said image data for game can be selectively displayed on said display means, record and reproduction means for said image manipulation display device being capable of sounding said music data for rest while the rest screen, the eye fatigue cancel screen, or the game screen is being displayed.

With this invention, the storage medium for image manipulation display is incorporated in the image manipulation display for displaying the rest screen, the eye fatigue cancel screen, or the game screen while the work screen is being displayed to carry out a specified work, thus a storage medium for image manipulation display which is well suited for automatically canceling the fatigue of the eyes or the stiffness of shoulders, eliminating the mental stresses, or canceling the stresses due to playing the game.

### SUMMARY OF THE INVENTION

The image manipulation display device according to the present invention provides an image manipulation display device which displays work screen in a display section 2, and carries out a specified work through the continuous operation with a keyboard 3, comprising an image memory 7 for storing any one or any two or more of image data for resting the eyes, muscles, or mind, image data for canceling the eye fatigue, and image data for game; and a CPU 5 which, for said display section 2, selects the work screen or any one or any two or more of rest screen based on the image data for rest which is stored in the image memory 7, eye fatigue cancel screen based on the image data for eye fatigue cancel which is stored in the image memory 7, and game screen based on the image data for game which is stored in the image memory 7.

### BRIEF DESCRIPTION OF THE DRAWINGS

FIG. 1(a) is a perspective side view showing a computer 1 which is an example of the image manipulation display device of the embodiment 1 of the present invention, as that of handy portable type.

FIG. 1(b) is a perspective side view showing a computer 1 which is an example of the image manipulation display device of the embodiment 1 of the present invention, as that of stationary desktop type.

FIG. 2 is a block diagram showing a computer of the embodiment 1 of the present invention.

FIG. 3 is a drawing showing an example of switching over the screen from the work screen to the rest screen and vice versa with a computer of the embodiment 1 of the present invention.

FIG. 4 gives timing charts illustrating of examples of switching over the screen from the work screen to the rest screen and vice versa with a computer of the embodiment 1 of the present invention.

FIG. 5 is a drawing showing an example of concurrent display of the work screen and the rest screen with a computer of the embodiment 1 of the present invention.

FIG. 6 is a drawing showing an example of display of the work screen and the rest screen in the multiwindow mode with a computer of the embodiment 1 of the present invention.

FIG. 7 is a drawing showing the work screen with a screen switchover notice message with a computer of the embodiment 1 of the present invention.

FIG. 8 is a drawing showing an example of sequential selection of the work screen, the rest screen, the eye fatigue cancel screen, and the game screen in the embodiment 2 of the present invention.

### DESCRIPTION OF THE PREFERRED EMBODIMENT

Hereinbelow, embodiments of the image manipulation display device and the storage medium for the same according to the present invention will be specifically described.

Embodiment 1

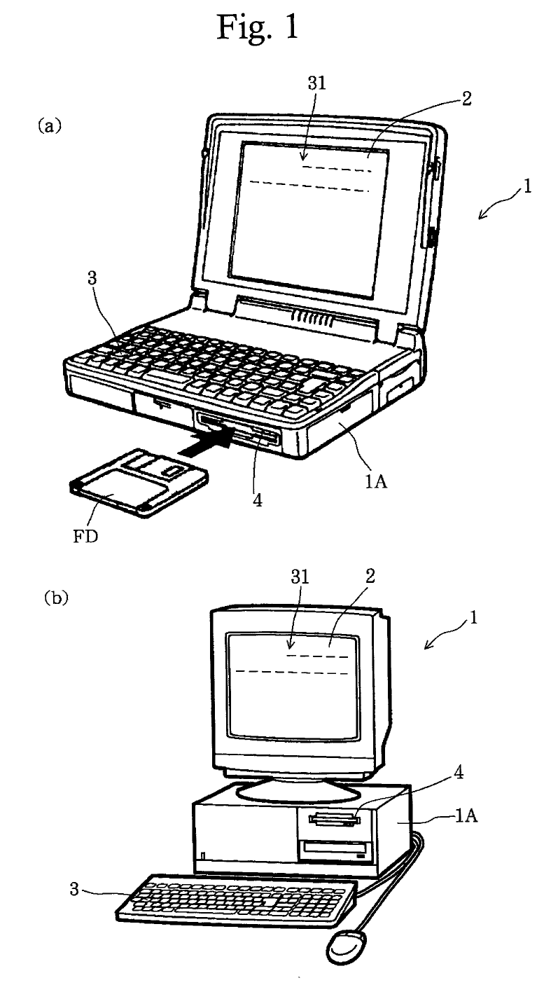

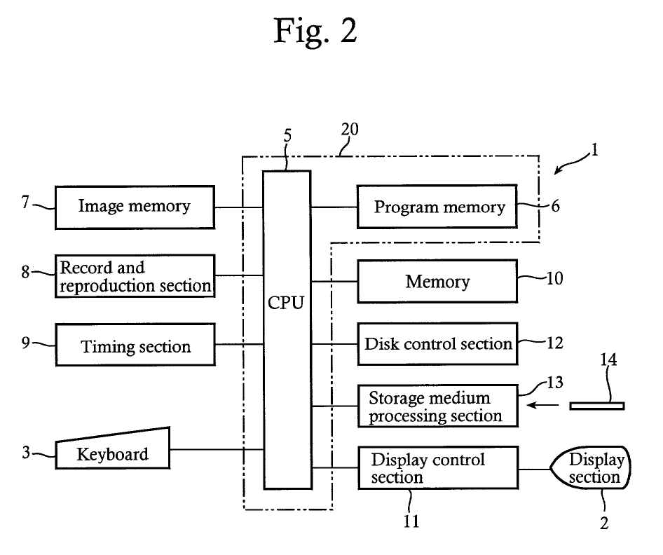

FIG. 1(a) and FIG. 2 show a computer 1 which is an example of the image manipulation display device of the embodiment 1 of the present invention, the computer 1 having a body 1A in a hexahedron shape, and the body 1A comprising a display section 2 made up of a liquid crystal for displaying a work screen 31 for document creation, for example, and a later described rest screen 32; a keyboard 3 as an input means for inputting characters, symbols and the like; and a slit 4 for a floppy disk FD.

FIG. 1(a) shows a computer 1 which is an example of the image manipulation display device of the embodiment 1 of the present invention, as that of handy portable type, however, the computer 1 which is an example of the image manipulation display device of the embodiment 1 of the present invention may, of course, be of stationary desktop type as shown in FIG. 1(b).

Said display section 2 may be either a CRT or a liquid crystal display.

As shown in FIG. 2., said computer 1 comprises a control means 20 composed of a CPU 5, which is control means for controlling the entire system, and a program memory 6 which stores a program for providing the operation described later.

For said CPU 5 are provided an image memory 7 which stores image data for use as a base of the later described rest screen 32 comprising a figure of a landscape of the nature or flowers, a figure stimulating the optic nerve of the eyes for ciliary muscle relaxation, a figure which can be considered effective for such a purpose as canceling the stiffness of shoulders, canceling the muscle fatigue in the body sections, or eliminating the mental stresses, or the like; a playback section 8 which can record, store, and reproduce a piece of music for rest (such as Träaumerei, Moonlight Sonata, and Nocturne by Chopin); a timing section 9 for counting the time; and a memory 10 for storing document data and the like; a display control section 11 for display controlling said display section 2; a disk control section 12 for read and write processing of data for said floppy disk FD; and a storage medium processing section 13 for taking in a storage medium 14 (such as a CD-ROM).

Next will be described the operation of said computer 1 which is an example of the image manipulation display device of the embodiment 1 of the present invention.

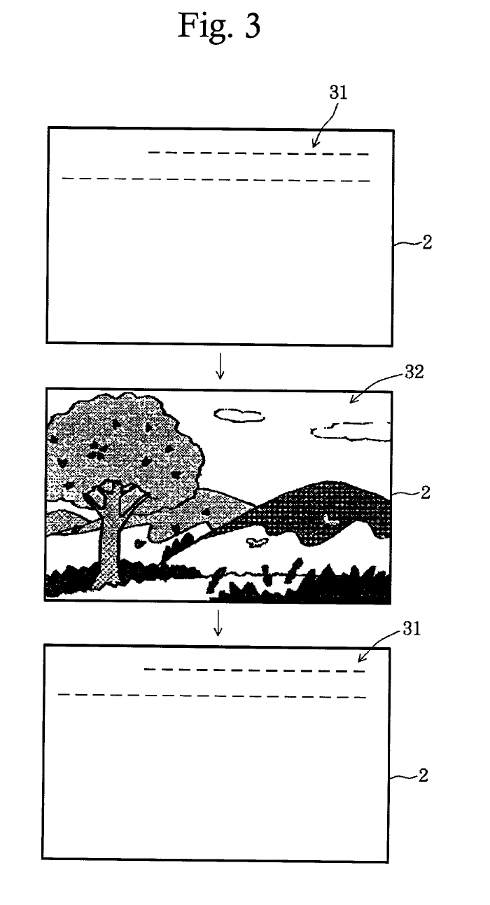

First, it is assumed that, as shown with a top picture in FIG. 3, the manipulator/worker displays said work screen 31 in the display section 2, and is performing document creation operation from the keyboard 3.

If this state continues for a certain period of time, the eyes and shoulders of the manipulator/worker will become fatigued with metal stresses being also built up, but, said CPU 5 will read out image data for a rest screen 32 comprising a landscape picture, for example, from the image memory 7 on the basis of said program, and switch over the display in the display section 2 from the work screen 31 to the rest screen 32 as shown with a middle picture in FIG. 3.

At the same time, the CPU 5 will operate said playback section 8 for sounding music for rest.

With the present invention, the form of display to be given on said rest screen 32 may be either a still image or a moving image.

The items which can be displayed on said rest screen 32 include an image which can be considered effective for disciplining and training the eyes, muscles and the mind, in addition to an image which can be regarded to be effective for such a purpose as canceling the fatigue of the eyes, canceling the stiffness of shoulders, canceling the muscle fatigue in the body sections, or eliminating the mental stresses.

Thus, the concept of rest as used in the term of said rest screen 32 also includes disciplining and training the eyes, muscles and the mind in addition to canceling the fatigue of the eyes, canceling the stiffness of shoulders, canceling the muscle fatigue in the body sections, eliminating the mental stresses, and the like.

The display time for said rest screen 32 and the sound time for rest music are set at, say, a few to ten minutes or so on the basis of the timing data in the timing section 9 by said CPU 5.

Thereafter, said CPU 5 stops the sound of the music for rest on said program, switching over the display in the display section 2 back to the work screen 31 from the rest screen 32.

In this case, it is, of course, possible to prepare said program so that said CPU 5 switches over the display in the display section 2 from the work screen 31 to the rest screen 32 with starting the music for rest, or switches over the display back to the work screen 31 from the rest screen 32 with stopping the music for rest at intervals of a certain time period (1 hr, for example).

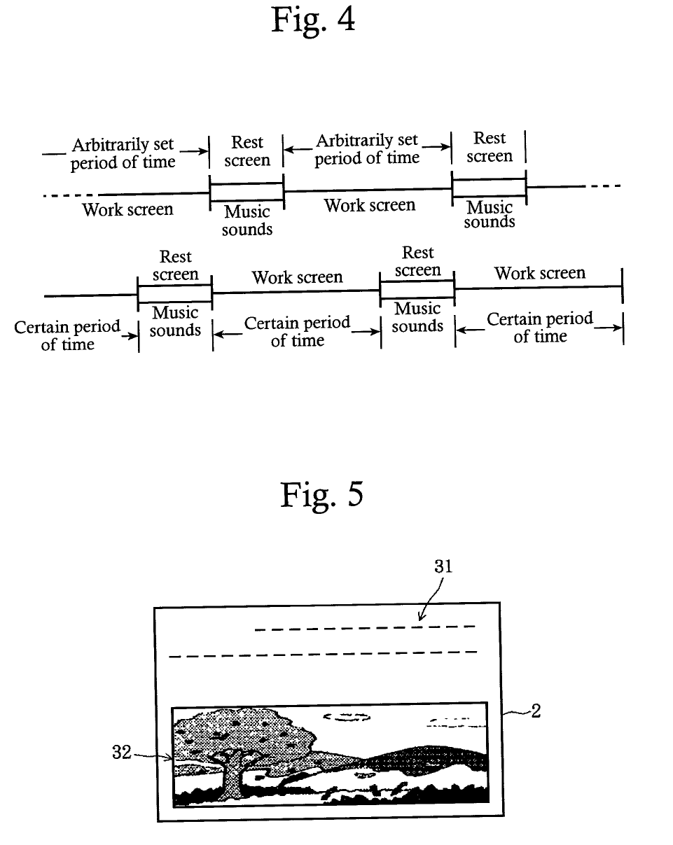

Further, it is possible that a special switching key (switching section) is provided on said keyboard 3 for allowing the manipulator/worker to use the switching key to switch over the display in the display section 2 from the work screen 31 to the rest screen 32 as with the case stated above. In this case, switching over the screen can be carried out according to the preference or the degree of fatigue of each particular individual manipulator/worker for providing a better working environment. FIG. 4 illustrates a series of operations involving manual switching over and that involving programmed switching over; the upper chart being for the former, and the lower one for the latter.

Thus, with the operation of the computer 1, the manipulator/worker of the computer 1 can view the rest screen 32, and listen to the music for rest for automatically recovering from the fatigue of the eyes and the stiffness of shoulders, and eliminating the mental stresses, which results in improvement of the working efficiency, and allows the working time to be prolonged.

In addition is offered an advantage of that, if the image of a figure, for example, stimulating the optic nerve of the eyes for ciliary muscle relaxation is displayed in said display section 2 as said rest screen 32, the manipulator/worker can not only cancel the fatigue of the eyes, but also recover the visual acuity through the stimulation of the optic nerve of the eyes for ciliary muscle relaxation.

FIG. 5 shows an example of concurrent display of said work screen 31 and said rest screen 32 in the display section 2 by dividing the display into two for providing the rest screen 32 under the work screen 31, for example.

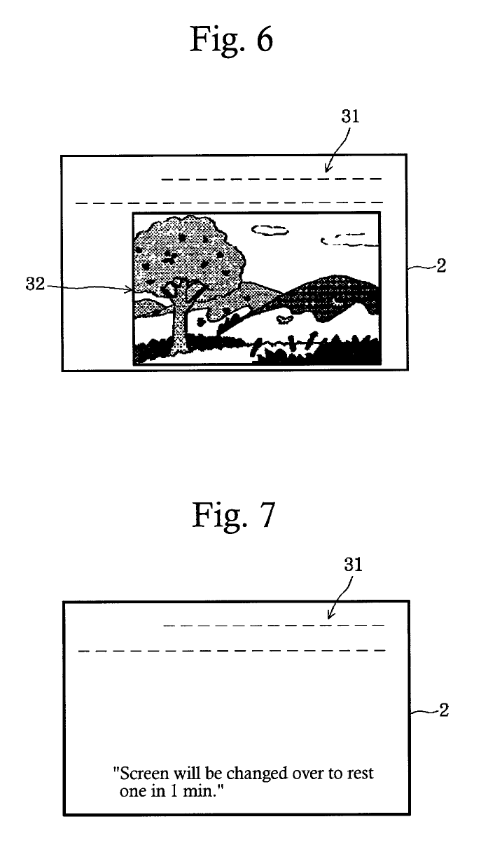

FIG. 6 shows an example of the rest screen 32 being displayed in the multiwindow mode in said work screen 31.

Thus, by displaying the work screen 31 and the rest screen 32 in the divided display or multiwindow mode, and sounding the music for rest while the rest screen 32 being displayed, the manipulator/worker can view the rest screen 32 for somewhat resting while continuing the work by means of the work screen 31, or view only the rest screen 32 for taking a complete rest while resting the eyes, and this feature allows the computer 1 to be used in wider application.

In addition, as shown in FIG. 7, said program can be prepared so that, while the work is being performed with the work screen 31 of the computer 1 being displayed, a screen switchover notice message, such as “Screen will be changed over to rest one in 1 min.”, is given at the bottom of the work screen 31. In this case, the program can also be prepared so that, when the manipulator/worker wants to continue the work for more than one minute regardless of the notice, the screen is switched over to the rest screen 32 in 10 minutes, for example, if the manipulator/worker depresses the switching key on said keyboard 3 for overriding the automatic function of screen switching over.

The embodiment 1 of the present invention has been explained for an application where a planar landscape image as a two-dimensional display is given as the rest screen 32, however, with the present invention, it is, of course, possible to display a three-dimensional solid image as the rest screen 32.

Further, in addition to a planar landscape image as used for explanation of the embodiment 1, this invention, of course, allows displaying, as the rest screen 32, characters, sentences, figures, designs, tables, patterns, pictures of animals and plants, and the like which can be considered effective for such a purpose as recovering from the fatigue of the eyes, canceling the stiffness of shoulders, canceling the muscle fatigue in the body sections, or eliminating the mental stresses.

As the rest screen 32, combinations of a landscape picture, characters, sentences, figures, designs, tables, patterns, pictures of animals and plants, and the like may, of course, be displayed.

Further, as the rest screen 32 may be displayed characters, sentences, figures, designs, tables, patterns, pictures of animals and plants, and the like, and combinations of these which can be considered effective for positively disciplining and training the eyes, muscles and the mind in addition to characters, sentences, figures, designs, tables, patterns, pictures of animals and plants, and the like, and combinations of these which can be regarded to be effective for such a purpose as canceling the fatigue of the eyes, canceling the stiffness of shoulders, canceling the muscle fatigue in the body sections, or eliminating the mental stresses.

It is also possible that, by previously writing a program for providing the operation of the above-stated embodiment 1 into said storage medium 14, and reading it by means of said storage medium processing section 13 for installation, the screen can be switched over from the work screen 31 to the rest screen 32 or vice versa with starting or stopping the music for rest in the same manner as described above.

In the above-stated embodiment 1, the screen switchover from the work screen 31 to the rest screen 32 or vice versa with the computer 1 has been explained, however, this scheme can also be applied to word processors, computer game machines and the like.

Especially for computer game machines, it is possible to prepare a program in such a way that the rest screen 32 is displayed with sounding the music for rest for a certain period of time in course of enjoying the game with the game screen, which is equivalent to the work screen, or the rest screen 32 is displayed with sounding the music for rest for a certain period of time every time one game is completed.

Further, it is also possible to scheme that the storage medium section 13 for reading the above-mentioned storage medium 14 in which a program is written is incorporated in a general television set, and the remote controller is used to switch over from the television screen in the television program that is being telecast, to the rest screen 32 for resting the eyes.

Embodiment 2

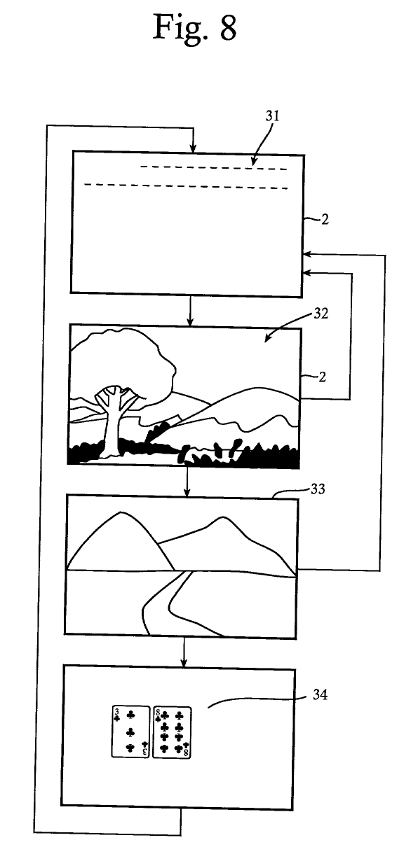

Next, the embodiment 2 of the present invention will be described with reference to FIG. 8.

In the above-stated embodiment 1, switchover of the screen from the work screen 31 to the rest screen 32 or vice versa has been explained, however, the embodiment 2 is characterized in that an eye fatigue cancel screen 33 based on the special image data for eye fatigue cancel or a game screen 34 based on the image data for game can be selected and displayed in addition to the above-mentioned screens.

In other words, the embodiment 2 is schemed so that the special image data for eye fatigue cancel on which the eye fatigue cancel screen 33 is based, and the image data for game, such as a cards game, on which the game screen 34 is based, in addition to the image data on which the rest screen 32 is based, are stored in said image memory 7, and on the program, said CPU 5 is operated to automatically or optionally select the work screen 31, the rest screen 32, the eye fatigue cancel screen 33, or the game screen 34 at a specified time.

In addition, with the embodiment 2, it is also possible that the manipulator/worker can operate the switching key on said keyboard for switching over the screen in the display section 2 from the work screen 31 to the rest screen 32, the eye fatigue cancel screen 33, or the game screen 34 at any time in the same manner as with the case stated above. In this case, switching over the screen can be carried out according to the preference or the degree of fatigue of each particular individual manipulator/worker for providing a better working environment.

As the eye fatigue cancel screen 33, a virtual far point display screen, such as a landscape picture as shown in FIG. 8, with which the ciliary muscle, which can change the refracting power of the crystal lens of the eye for focusing, is released from a particular near point to focus on a far point for practicing the eye fatigue cancel.

Sounding of the music for rest is programmed to be activated with the rest screen 32 or the eye fatigue cancel screen 33 being displayed.

It is also possible that, by incorporating, in said storage medium 14, an operation program containing image data for resting the eyes, muscles, or mind, image data for canceling the eye fatigue, data for game, and music data for rest, and installing the operation program into the computer 1 from this storage medium 14, the work screen 31, the rest screen 32, the eye fatigue cancel screen 33, or the game screen 34 can be selected and displayed at a specified time in the same manner as with the case stated above.

The present invention as specifically stated above in the embodiments 1 and 2 provides an image manipulation display device which comprises image memory means for storing any one or any two or more of image data for resting the eyes, muscles, or mind, image data for canceling the eye fatigue, and image data for game; display means; and control means which, for said display means, selects the work screen or any one or any two or more of the rest screen based on the image data for rest which is stored on said image memory means, the eye fatigue cancel screen based on the image data for eye fatigue cancel which is stored on said image memory means, and the game screen based on the image data for game which is stored on said image memory means.

The present invention also provides an image manipulation display device which comprises image memory means for storing any one or any two or more of image data for resting the eyes, muscles, or mind, image data for canceling the eye fatigue, and image data for game; display means; record and reproduction means for recording and reproducing a piece of music for rest; and control means which, for said display means, selects the work screen or any one or any two or more of the rest screen based on the image data for rest which is stored on said image memory means, the eye fatigue cancel screen based on the image data for eye fatigue cancel which is stored on said image memory means, and the game screen based on the image data for game which is stored on said image memory means, and sounds the piece of music recorded on said record and reproduction means while the rest screen, the eye fatigue cancel screen, or the game screen is being displayed.

With the present invention as such, said control means allows the manipulator/worker to arbitrarily and freely set the switchover timing for the work screen, the rest screen, the eye fatigue cancel screen, and the game screen; said input means comprises a switching section for the work screen, the rest screen, the eye fatigue cancel screen, and the game screen; and said control means selects the work screen, or any one or any two or more of the rest screen, the eye fatigue cancel screen, and the game screen in response to a signal from said switching section.

Further, the storage medium for the image manipulation display device of the present invention is a storage medium for image manipulation display device which can function, being incorporated in an image manipulation display device which displays the work screen on the display means, and carries out a specified work through the continuous operation with the input means, wherein an operation program which contains any one or any two or more of image data for resting the eyes, muscles, or mind, image data for canceling the eye fatigue, image data for game, and music data for rest is stored; and under control by the control means for said image manipulation display device, the work screen or any one or any two or more of the rest screen based on said image data for rest, the eye fatigue cancel screen based on said image data for eye fatigue cancel, and the game screen based on said image data for game can be selectively displayed on said display means, the record and reproduction means for said image manipulation display device being capable of sounding said music data for rest while the rest screen, the eye fatigue cancel screen, or the game screen is being displayed.

The present invention can offer an image manipulation display device which allows automatically recovering from the fatigue of the eyes and the stiffness of shoulders, while eliminating the mental stresses, and also allows enjoying the game at any time.

In addition, the present invention can offer a storage medium for image manipulation display device which stores a specified operation program, and which, being incorporated in the image manipulation display device, allows comfortable image manipulation and display for automatically canceling the eye fatigue and the stiffness of shoulders of the manipulator/worker, while eliminating the mental stresses.

What is claimed is:

1. An image manipulation display device which displays work screen on display means, and carries out a specified work through the continuous operation with input means, comprising:
image memory means for storing any one or any two or more of image data for resting the eyes, muscles, or mind, image data for canceling the eye fatigue, and image data for game; and
control means which, for said display means, selects said work screen or any one or any two or more of rest screen based on the image data for rest which is stored on said image memory means, eye fatigue cancel screen based on the image data for eye fatigue cancel which is stored on said image memory means, and game screen based on the image data for game which is stored on said image memory means.

2. An image manipulation display device which displays work screen on display means, and carries out a specified work through the continuous operation with input means, comprising:
image memory means for storing any one or any two or more of image data for resting the eyes, muscles, or mind, image data for canceling the eye fatigue, and image data for game;
record and reproduction means for recording and reproducing a piece of music for rest; and
control means which, for said display means, selects said work screen or any one or any two or more of rest screen based on the image data for rest which is stored on said image memory means, eye fatigue cancel screen based on the image data for eye fatigue cancel which is stored on said image memory means, and game screen based on the image data for game which is stored on said image memory means, and sounds the piece of music recorded on said record and reproduction means while the rest screen, the eye fatigue cancel screen, or the game screen is being displayed.

3. An image manipulation display device as set forth in claim 1 or 2, wherein said control means has a function which allows a manipulator/worker to arbitrarily and freely set the switchover timing for the work screen, the rest screen, the eye fatigue cancel screen, and the game screen.

4. An image manipulation display device as set forth in any one of claims 1 to 3, wherein said input means comprises a switching section for the work screen, the rest screen, the eye fatigue cancel screen, and the game screen, and said control means selects the work screen, or any one or any two or more of the rest screen, the eye fatigue cancel screen, and the game screen in response to a signal from said switching section.

5. A storage medium for image manipulation display which can function, being incorporated in an image manipulation display device which displays work screen on display means, and carries out a specified work through the continuous operation with input means, wherein
an operation program which contains any one or any two or more of image data for resting the eyes, muscles, or mind, image data for canceling the eye fatigue, image data for game, and music data for rest is stored; and
under control by control means for said image manipulation display device, the work screen or any one or any two or more of rest screen based on said image data for rest, eye fatigue cancel screen based on said image data for eye fatigue cancel, and game screen based on said image data for game is selectively displayed on said display means, record and reproduction means for said image manipulation display device being capable of sounding said music data for rest while the rest screen, the eye fatigue cancel screen, or the game screen is being displayed.
